(19) United States
(12) Patent Application Publication
(10) Pub. No.: US 2004/0253150 A1
(43) Pub. Date: Dec. 16, 2004

(54) Container, apparatus and method for transferring and metering a pourable material

(75) Inventor: Peter Kirschenbuhler, Herisau (CH)

Correspondence Address: SHOEMAKER AND MATTARE, LTD, 10 POST OFFICE ROAD - SUITE 110, SILVER SPRING, MD, 20910, US

(73) Assignee: Metrohm AG, Herisau (CH)

(21) Appl. No.: 10/848,112

(22) Filed: May 19, 2004

(30) Foreign Application Priority Data
May 26, 2003 (EP) 03405376.9

(51) Int. Cl. B01L 3/02; B32B 5/02

(52) U.S. Cl. 422/100

(57) ABSTRACT

The invention relates to a container 1 for pourable materials, in particular powdered materials M, for use on a robot arm R, with a conveying device 3 in a cylindrical housing 2, the cylindrical housing 2 being formed as a receiving space for the material M, in which the conveying device 3 is arranged in such a way that it can be driven in both directions transversely in relation to the longitudinal axis of the conveying device for receiving and discharging the material M.

The invention relates to containers for transferring and metering pourable materials, in particular powdered materials, according to the preamble of claim 1, apparatuses for automatically transferring and metering pourable materials, in particular powdered materials, according to the preamble of claim 8, coupling devices according to the preamble of claim 11 and methods for transferring and metering according to the preamble clause of claim 12.

Automatic metering apparatuses for powdered materials are known per se, in particular in the area of chemical engineering.

EP-A2-0 287 708 discloses a computer-controlled apparatus for weighing dyes. This involves using a plurality of silos, which respectively have a conveying worm at their lower end. A movable carriage with a drive device can move up to the individual silos and the drive device can be connected to the respective conveying worm. On the opposite side of the silos there is—likewise on the carriage—a weigher, into which the dye powder is conveyed. One particular disadvantage of this apparatus is the necessity for a multiplicity of permanently installed, separate conveying worms, resulting in restricted flexibility of the apparatus. The high overall structural complexity of the apparatus due to the complex construction of the silos is also disadvantageous.

EP-A1-0 446 398 likewise discloses a computer-controlled apparatus for metering powdered materials. A multiplicity of silos which respectively have a conveying worm in their lower region are also provided in this system. According to the command of a control unit, a weighing carriage moves up to the individual silos and receives the predetermined amount of the respective material. Additionally provided is a robot arm, which can place a weighing vessel on the weighing carriage and remove it again from the latter. Such an arrangement is not suitable for the most variable possible transferring of powdered materials.

It is therefore an object of the invention to avoid the disadvantages of the known art; in particular, that is to provide an apparatus for automatically metering pourable materials, in particular powdered materials, which is distinguished by generally high variability. In particular, it is a further object of the invention to permit the conveying and metering of the widest variety of pourable materials, in particular powdered materials, with lowest possible structural complexity, in particular of the supply containers.

According to the invention, these objects are solved by a container and an apparatus for transferring and metering, in particular automatically transferring and metering, pourable materials, in particular powdered materials, a coupling device and a method according to the characterizing portions of the independent claims.

The invention relates to a container for transferring and metering a pourable material, in particular a powdered material, with a conveying device in a cylindrical housing, the cylindrical housing being formed as a receiving space for the material, in which the conveying device is arranged in such a way that it can be driven in both directions transversely in relation to the longitudinal axis of the conveying device for receiving and discharging the material.

The outside diameter of the conveying device is made to match the inside diameter of the cylindrical housing, in particular in such a way that the conveying device can be rotated in the cylindrical housing, but unchecked lateral escape of the material to be conveyed is avoided by a snug fit of the conveying device in the cylindrical housing. It is particularly advantageous if the container can be dismantled, in particular for cleaning purposes, and reused. The container advantageously consists of a chemically inert and easily injection-mouldable plastic or mixtures of such plastics, in particular polyvinyl chloride (PVC), polyethylene (PE), polyurethane (PU) or polyamide (PA).

A conveying screw is used with particular preference as the conveying device. It goes without saying that, depending on the material to be conveyed, a conveying device, in particular a conveying screw, which is appropriate for the specific properties of the material to be conveyed may be chosen if required. In particular, the helix angle of the planes of a conveying screw and the roughness of the surfaces may be adapted to the material respectively to be conveyed, in order to ensure optimum pouring behaviour. Moreover, if required, the robot arm may be moved by a starting and/or braking ramp. Alternatively or in addition, after receiving the material, the conveying device may also continue to be rotated briefly in the receiving direction in a state in which it is extended from the supply container.

During operation, the material to be conveyed is received in the container by rotation of the conveying device in one of the two possible directions transversely on rotation to the longitudinal axis of the conveying device. Discharge of the material to be conveyed out of the container is possible by rotation of the conveying device in the opposite direction.

In a preferred embodiment, a coupling device is provided in an end region of the container, for reception on a robot arm, the coupling device fixing in particular the cylindrical housing of the container in such a way that it is secured against twisting. The combination of a container according to the invention and a robot arm can achieve a particularly high degree of variability and versatility in use.

In a further particularly preferred embodiment, the conveying device additionally has in its end region facing the coupling device for reception on a robot arm a coupling device for connection to the drive device. This drive device may in this case be provided directly in the robot arm. However, a drive shaft for transmission is also possible for example, so that the drive unit itself can be accommodated further away, for example in a base station of the robot. A receptacle may also be optionally provided on the robot arm, in order to fix and transport sample vessels and/or supply containers, in particular beaded rim vessels.

The container according to the invention is used particularly advantageously on a robot arm in conjunction with an automatic sample processing system (“sample processor”) of a type known per se, in particular in a microprocessor-controlled manner. During operation, a material to be metered that is in a vessel is then located in a holding device of the automatic sample processing system. It goes without saying that it is also possible for a number of vessels with extremely different materials to be metered to be arranged on the sample processing system. Likewise in a holding device of the automatic sample processing system there is a supply of containers for transferring and metering the material. At an external position, or likewise in the automatic sample processing system, there is a weighing device, on which a weighing vessel can be positioned, in particular also by the robot arm. The robot arm picks up a container from the holding device with the supply of containers and subsequently moves to the position of the automatic sample processing system at which the material to be metered is located. The robot arm with the container is lowered into the material to be metered and the material is received in the container by rotation of the conveying device. With the material received in the container, the robot arm subsequently moves to the position of the weighing device. By rotation, in particular slow rotation, of the conveying device in the opposite direction, the material to be metered is discharged from the container onto the weighing device. Particularly advantageously, the arrangement has communication means between the weighing device and the automatic sample processing system. This allows the weight of the amount of material already discharged onto the automatic sample processing system to be continuously transmitted to the automatic sample processing system and the rotation of the conveying device to be ended when the preset weight to be achieved is reached. Optionally, the automatic sample processing system additionally has an electronic control, which makes it possible to control the rotation of the conveying device as a function of the weight detected by the weigher, in particular in an infinitely variable manner. It is particularly advantageous to choose the metering increments to be smaller and/or to choose a slower rotation of the conveying device, the more the amount of material already discharged approaches the predetermined weight. As a result, achievement of the predetermined weight as exactly as possible is ensured. After the weighing operation, the weighing vessel is optionally removed from the weighing device, for example by a receiving fork of the robot arm, and an empty weighing vessel is subsequently positioned on the weighing device. Completely automated operation, even when metering a number of samples, is possible by the arrangement described.

According to a further preferred embodiment, the cylindrical housing of the container has a profiling, in particular a projection or a recess, which permits automated stripping of the container from a robot arm. When metering a number of different materials, it is necessary for the containers to be changed in order to avoid cross-contamination. Such changing of the containers preferably takes place automatically. A raised ring on the cylindrical housing is suitable for example as the profiling. The subsequent reception of a new container takes place as described above.

According to a further preferred embodiment, the coupling device for connecting the conveying device to a drive unit is formed by mechanically interengaging parts. Slotted-screw, cross-slotted-screw or torque connections can be used particularly advantageously for this.

According to a further, particularly preferred embodiment, the coupling device for receiving the container on a robot arm is conically formed. Compatible with the cone of the container is a cone of the robot arm. The cone of the container is preferably formed as a conical depression and the cone of the robot arm is preferably formed as a raised cone. In the operating state, the container fits on the robot arm with an exact press fit. By virtue of its mechanical simplicity, such a coupling device offers a good compromise between stability of the connection and easy automatic strippability.

According to a particularly preferred exemplary embodiment, the container has in the region of the coupling device a conical depression with an apex angle of between 0.5° and 15°, preferably between 2° and 5°, particularly preferably of about 2.8°, which is compatible with a cone of the robot arm. An apex angle of between 0.5° and 15°, preferably between 2° and 5°, particularly preferably of about 2.8°, has proven to be a particularly advantageous compromise between the strength of the connection between the container and the robot arm on the one hand and the necessary strippability for the exchange of the container on the other hand. It goes without saying that an individual adaptation of the apex angle is possible, in particular depending on the material of the container and the cone of the robot arm.

The containers according to the invention can be used particularly advantageously in apparatuses for automatically transferring and metering pourable materials, in particular powdered materials. Such apparatuses advantageously have at least one robot arm for receiving a container according to the invention. By virtue of the automatable and easy exchangeability of the container, a high degree of versatility of the apparatus is achieved; in particular, the avoidance of cross-contamination is easily ensured by the use of containers for each material to be metered.

In a particularly preferred exemplary embodiment, the apparatus for automatically transferring and metering pourable materials, in particular powdered materials, has an electronic feedback loop between an automatic sample processing system and a weighing device. As a result, particularly exact metering of a preset weight is made possible. The communication means necessary for this between the weighing device and the automatic sample processing system may also be formed in particular in a wireless manner. An electronic feedback loop allows the weight of the amount of material already discharged onto the automatic sample processing system to be continuously transmitted to the automatic sample processing system and the rotation of the conveying device to be ended when the preset weight to be achieved is reached. Optionally, the automatic sample processing system additionally has an electronic control, which makes it possible to control the speed of the rotation of the conveying device and/or the metering increment as a function of the weight detected by the weigher, in particular in an infinitely variable manner. It is particularly advantageous here to choose the metering increments to be smaller, by slower rotation of the conveying device, the more the amount of material already discharged approaches the predetermined weight. As a result, achievement of the predetermined weight as exactly as possible is ensured.

In a further particularly preferred exemplary embodiment, the weighing device is arranged in the robot arm, in particular directly adjacent to the container. This makes it possible to dispense with all the transporting of the weighing vessel to an external weighing position and back from the latter. Moreover, a particularly sensitive response of the weighing device to changes in weight in the container can be achieved, and accordingly particularly exact reaching of the preset weight of the material to be metered can be accomplished.

The use of a screw conveyor as a transfer container evidently leads to a flexible transfer and metering arrangement which can be used in various ways.

The invention is explained in more detail below on the basis of drawings and exemplary embodiments, without restricting the invention to these. In the drawing:

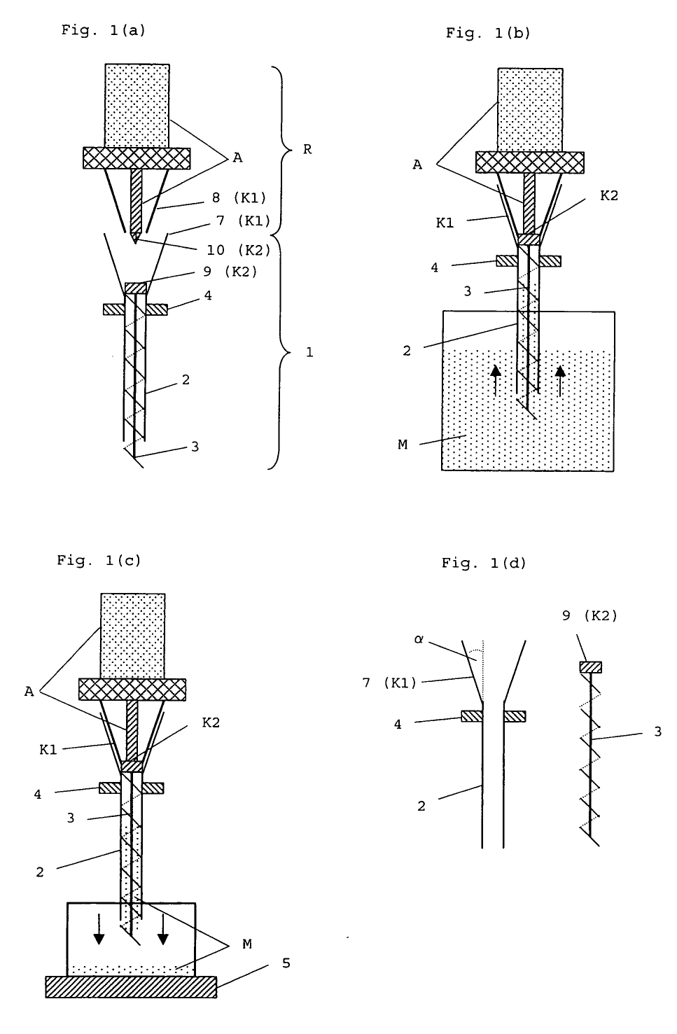

FIG. 1(a) the container and the robot arm, separated;

FIG. 1(b) the container on the robot arm, reception of the material to be metered;

FIG. 1(c) the container on the robot arm, discharge of the material to be metered;

FIG. 1(d) the container, dismantled;

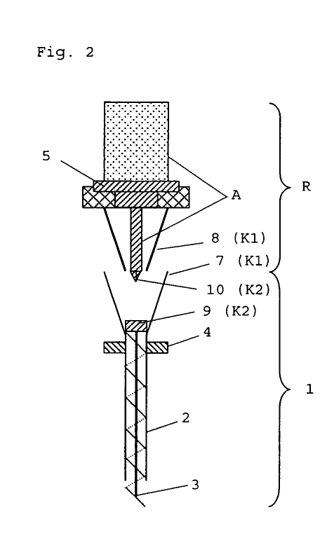

FIG. 2 the container and the robot arm with an integrated weighing device.

FIG. 1 shows a container 1 for transferring and metering a pourable material, in particular powdered material, and also a robot arm R for receiving the container 1. The container 1 has a cylindrical housing 2, in which a conveying device 3 is mounted such that it can rotate in both directions transversely in relation to the longitudinal axis. Conveying worms or screws are preferably used for example as the conveying device 3. It goes withtout saying that, depending on the material to be conveyed, a conveying device 3 which is appropriate for the specific properties of the material to be conveyed may be chosen if required. In particular, the helix angle of the planes of a conveying screw and the roughness of the surfaces may be adapted to the material respectively to be conveyed, in order to ensure optimum pouring behaviour. Moreover, if required, the robot arm R may be moved by a starting and/or braking ramp. Alternatively or in addition, after receiving the material, the conveying device 3 may also continue to be rotated briefly in the receiving direction in a state in which it is extended from the supply container. The container 1 optionally has a profiling 4, for example a ring running around the cylindrical housing 2.

This profiling 4 permits automated stripping of the container 1 from the robot arm R. In addition, a coupling device K1 for receiving the container 1 is provided on the robot arm R. In the embodiment shown, the coupling device K1 is formed on the robot arm as a cone 8 and on the container 1 as a conical depression 7. In this case, the container 1 fits on the robot arm R with an exact press fit, whereby the cylindrical housing 2 is fixed on the robot arm (R) in such a way that it is secured against twisting. It goes without saying that other coupling devices K1, such as for example screw couplings, are also possible. For transferring a rotational movement from a drive A accommodated in the robot arm R to the conveying device 3, a further coupling device K2 is provided. On the container 1, the coupling device K2 is provided for example as a slot 9, on the robot arm R it is formed as a projection 10 which is compatible with this slot. Slotted-screw, cross-slotted-screw and torque connections are suited particularly advantageously as particularly advantageous connections.

FIG. 1(b) shows a container 1 located on a robot arm R during the reception of a material M to be conveyed or metered. The fixing of the container 1 to the robot arm is ensured by means of the coupling device K1 in the way already described. The coupling device K2 ensures the transmission of a rotational movement of the drive A to the conveying device 3. The reception of a container 1 by the robot arm is not explicitly shown. This may take place in a way known per se, in an automated manner, for example at a position of an automatic sample processing system (“sample processor”) where a supply of containers is located. It goes without saying that this supply may also be located at a position external from the automatic sample processing system. The exact press fit of the coupling device K1 makes receiving of the container easily possible by simply pressing the robot arm onto the container 1. During operation, the material M to be conveyed is received in the container 1 by an upwardly directed rotation of the conveying device. Depending on the form of the container 1 and of the conveying device 3, amounts of 10 mg to 5 g can be received in particular; adaptation of the capacity is easily possible by routine structural work.

FIG. 1(c) shows the discharge of the material M to be conveyed, for example at another position of an automatic sample processing system or an external position. A downwardly directed rotational movement of the conveying device 3 has the effect of releasing the material M to be conveyed from the container 1 into a vessel arranged on a weighing device 5. It is particularly preferred for communication means to be provided between the automatic sample processing system or drive device A and the weighing device 5, so that the rotational movement of the conveying device 3 is stopped when the preset weight is reached. Preferably provided for this is an electronic feedback loop, by means of which in particular the conveying speed can also be controlled, preferably in an infinitely variable manner, so that the conveying speed can be slowed when the required weight is approached. This allows particularly precise achievement of the required weight to be ensured.

In FIG. 1(d), the cylindrical housing 2 and the conveying device 3 of a container 1 are shown separated from each other. The container 1 can preferably be reversibly dismantled, at least into these two component parts, in order in particular to ensure efficient cleaning, and consequently that the container 1 can be reused. The coupling device K1 is preferably formed as a conical depression which has an apex angle (α) of between 0.5° and 15°, preferably between 2° and 5°, particularly preferably of about 2.8°.

In FIG. 2, a particularly preferred embodiment is shown, the weighing device 5 being integrated in the robot arm. As a result, particularly sensitive response of the weighing device 5 to changes in weight in the container 1 can be achieved, and accordingly particularly exact reaching of the preset weight of the material M to be metered can be accomplished.

1. A container for transferring and metering a pourable material, comprising a conveying device and a cylindrical housing,
wherein the conveying device is arranged in the cylindrical housing, and
wherein the cylindrical housing is formed as a receiving space for the material, in which the conveying device is arranged in such a way that it adapted to be driven in both directions transversely in relation to the longitudinal axis of the conveying device for receiving and discharging the material.

2. A container according to claim 1, further comprising a coupling device,
wherein said coupling device is provided in an end region of the container for reception on a robot arm, the coupling device fixing the cylindrical housing of the container in such a way that it is secured against twisting.

3. A container according to claim 2, wherein the conveying device has in its end region facing the coupling device a coupling device for connection to a drive device.

4. A container according to claim 2, wherein the cylindrical housing has a profiling, which permits automated stripping of the container from a robot arm.

5. A container according to claim 4, wherein the profiling is a projection or a recess.

5. A container according to claim 3, wherein the coupling device is formed by mechanically engaging parts.

6. A container according to claim 2, wherein the coupling device is conically formed.

7. A container according to one of claim 2, wherein the container has in the region of the coupling device a conical depression with an apex angle of between 0.5° and 15°, preferably between 2° and 5°, particularly preferably of about 2.8°, which is compatible with a cone of the robot arm.

8. An apparatus for automatically transferring and metering pourable materials, comprising a container,
said container including a conveying device and a cylindrical housing,
wherein the conveying device is arranged in the cylindrical housing, and
wherein the cylindrical housing is formed as a receiving space for the material, in which the conveying device is arranged in such a way that it adapted to be driven in both directions transversely in relation to the longitudinal axis of the conveying device for receiving and discharging the material.

9. An apparatus according to claim 8, wherein a feedback loop between an automatic sample processing system and a weighing device permits the metering of a preset weight.

10. An apparatus according to claim 9, wherein the weighing device is integrated in the robot arm.

11. A coupling device for the connection of a container to a robot arm, wherein the container has a conical depression with an apex angle of between 0.5° and 15°, preferably between 2° and 5°, particularly preferably of about 2.8°, which is compatible with a cone of the robot arm.

12. A method for transferring and metering pourable materials, in particular powdered materials, with the following steps:
(i) provision of a container with a conveying device in a cylindrical housing, the cylindrical housing being formed as a receiving space for the material, in which the conveying device is arranged in such a way that it adapted to be driven in both directions transversely in relation to the longitudinal axis of the conveying device for receiving and discharging the material;
(ii) lowering of the container, preferably on a robot arm, into the material and receiving of the material (M) by rotation of the conveying device in a first direction transversely in relation to the longitudinal axis of the conveying device;
(iii) transfer of the container and discharge of the material (M) onto a weighing device and/or in a controlled manner by a weighing device arranged in particular in a robot arm, the discharge of the material taking place by rotation of the conveying device in a second direction transversely in relation to the longitudinal axis of the conveying device.
